(19) United States
(12) Patent Application Publication
(10) Pub. No.: US 2011/0259658 A1
(43) Pub. Date: Oct. 27, 2011

(54) Power output device for wheeled vehicle

(76) Inventors: Lin Hsiang Huang, Taipei (TW); Chia Liang Lin, Taipei (TW); Tung Ching Lin, Taipei (TW)

(21) Appl. No.: 12/799,324

(22) Filed: Apr. 22, 2010

(51) Int. Cl. B60K 1/00

(52) U.S. Cl. 180/65.51

(57) ABSTRACT

A power output device includes a spindle for attaching to a fork of a wheeled vehicle, a housing for attaching to a wheel and rotatably attached onto the spindle, a container disposed in the housing, a stator disposed in container, a rotor rotatably attached to the spindle, a gear attached to the rotor, a gear wheel secured to the container, a number of pinions engaged with the gear and the gear wheel and attached between two plates, an output shaft attached to one of the plates and attached to the container, and a control device having one or more batteries attached to the container, and an electric mechanism for operating the rotor and the gear to rotate relative to the stator and to rotate or drive wheel of the wheeled vehicle.

### BACKGROUND OF THE INVENTION

1. Field of the Invention

The present invention relates to a power output device, and more particularly to a power output device for attaching to a wheel of a wheeled vehicle and for selectively rotating or driving the wheel of the wheeled vehicle.

2. Description of the Prior Art

Typical power output devices for wheeled vehicles, such as the unicycles, the bicycles, the tricycles, the motor cycles, the electric-powered cycles, etc. comprise a large battery attached to the wheeled vehicles, and a number of parts or elements to be separately attached to the wheeled vehicles such that the typical power output devices may not be easily attached or assembled to the wheeled vehicles by the users themselves and should be attached or assembled to the wheeled vehicles by the specially trained persons only.

For example, U.S. Pat. No. 4,677,328 to Kumakura discloses one of the typical generators for use on bicycles and comprising a rotor attached to one of a pair of spoke suspending hub flanges that is rotatably mounted on an axle of a bicycle, and a stator fixed mounted on the axle.

However, the generator is attached to one side of the spoke suspending hub, and may only be used to generate an electric power only, but may not be used to rotate or drive the spoke suspending hub and/or the wheels of the bicycles.

U.S. Pat. No. 5,015,869 to Schurmann et al. discloses another typical dynamo for use on bicycles and comprising a housing for accommodating a stator and a rotor which can be set in rotary motion by a drive member that is mounted rotatably around a wheel axle.

However, similarly, the dynamo may only be used to generate an electric power only, but may not be used to rotate or drive the spoke suspending hub and/or the wheels of the bicycles.

U.S. Pat. No. 6,002,192 to Krivospitski et al. discloses a further typical drive for transportation facilities comprising a spindle with a stator, and a rotor rotatably mounted on the stator, for forming an electric motor and a rim.

However, the drive may not be used to generate a great amount of the electric power to suitably rotate or drive the spoke suspending hub and/or the wheels of the bicycles.

U.S. Pat. No. 6,501,199 to Hung discloses a still further typical automatic wheel-driven generating means comprising a winding reel enclosed between left and right magnetic poles, and a magnet holder having a cap screwed into a center thereof and being fixed mounted on the wheel axle.

However, similarly, the wheel-driven generating means is attached to one side of the spoke suspending hub, and may only be used to generate an electric power only, but may not be used to rotate or drive the spoke suspending hub and/or the wheels of the bicycles.

The invention has arisen to mitigate and/or obviate the afore-described disadvantages of the conventional power output devices.

### SUMMARY OF THE INVENTION

The primary objective of the present invention is to provide a power output device for attaching to a wheel of a wheeled vehicle and for selectively rotating or driving the wheel of the wheeled vehicle.

In accordance with one aspect of the invention, there is provided a power output device for attaching to a wheel and a fork mechanism of a wheeled vehicle, comprising a spindle for attaching to the fork mechanism of the wheeled vehicle, a housing for attaching to the wheel of the wheeled vehicle and including a chamber formed therein, the housing being rotatably attached onto the spindle, a motor assembly including a container disposed in the chamber of the housing and having a compartment formed therein, a cover attached to a side portion of the container, a stator disposed in the compartment of the container and secured to the container, a rotor engaged in the compartment of the container and rotatably attached to the spindle, a gear attached to the rotor and rotated in concert with the rotor, a gear wheel secured to the cover of the container and including a number of teeth formed therein, a number of pinions engaged with the gear and the teeth of the gear wheel, and rotatably attached between two plates, an output shaft attached to one of the plates and attached to the container, and a control device including at least one battery engaged in the chamber of the housing and attached to the container, and including an electric mechanism for operating the rotor of the motor assembly.

The cover of the container includes a number of depressions formed therein, and the gear wheel includes a number of projections extended radially and outwardly therefrom for engaging with the depressions of the cover and for anchoring and securing the gear wheel to the cover of the container.

The cover and the container include a number of fins extended outwardly therefrom for heat dissipating purposes. The electric mechanism includes a signal receiver, a sensor, a torque detector and a navigating device.

The control device includes a casing engaged in the chamber of the housing and having an opening formed therein for receiving the container, and the at least one battery is engaged in the casing.

The motor assembly includes a carrier disposed in the compartment of the container and secured to the container, and the stator is secured onto the carrier. The spindle includes a peripheral flange engaged with the container for anchoring the container to the spindle.

A sprocket wheel may further be provided and attached to the output shaft. For example, the sprocket wheel may be attached to the output shaft directly or indirectly with a coupler.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating a wheeled vehicle, such as the bicycle employing a power output device in accordance with the present invention;

FIG. 2 is a partial cross sectional view of the power output device for the wheeled vehicle, and is taken along lines 2-2 of FIG. 1;

FIG. 3 is a partial exploded views of the power output device for the wheeled vehicle;

FIG. 4 is a cross sectional view of the power output device for the wheeled vehicle taken along lines 4-4 of FIG. 3;

FIG. 5 is another partial exploded view of the power output device for the wheeled vehicle;

FIG. 6 is a cross sectional view of the power output device for the wheeled vehicle taken along lines 6-6 of FIG. 4;

FIG. 7 is a partial perspective view of the power output device, in which a portion of the power output device has been cut off for showing the inner structure of the power output device;

FIG. 8 is a further partial exploded view of the power output device as shown in FIG. 7;

FIG. 9 is a still further partial exploded view of the power output device for the wheeled vehicle; and

FIG. 10 is a partial cross sectional view illustrating the operation of the power output device for driving or operating the wheeled vehicle.

### DETAILED DESCRIPTION OF THE PREFERRED EMBODIMENT

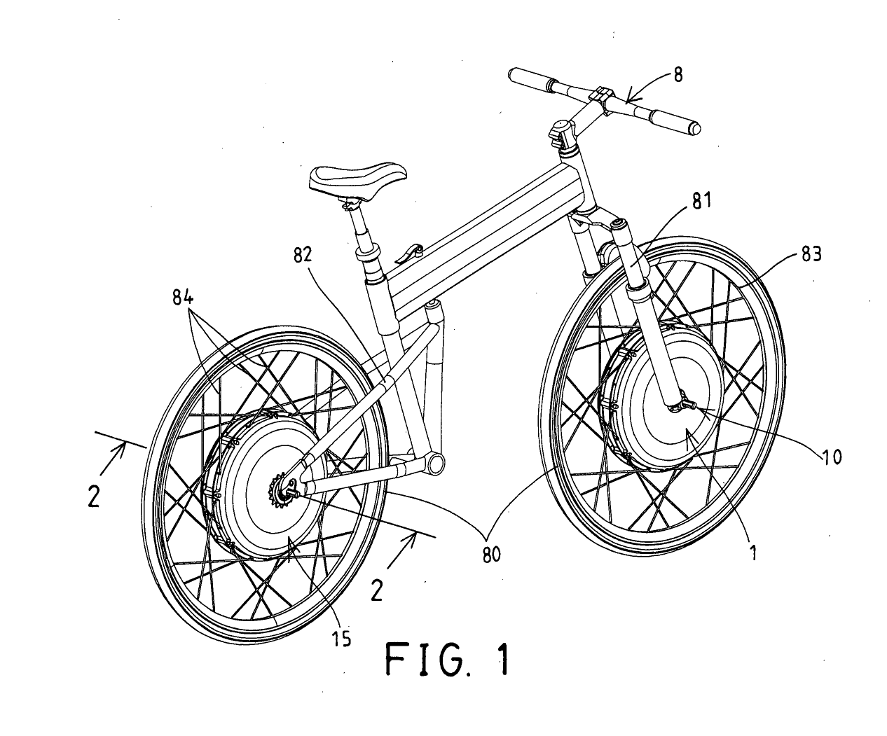

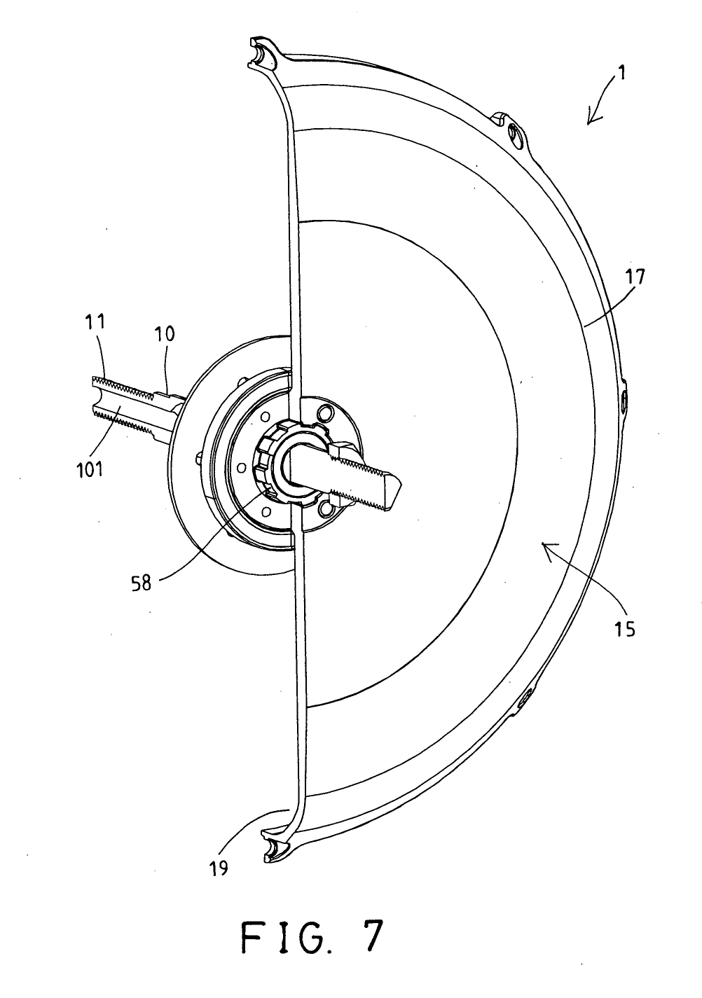

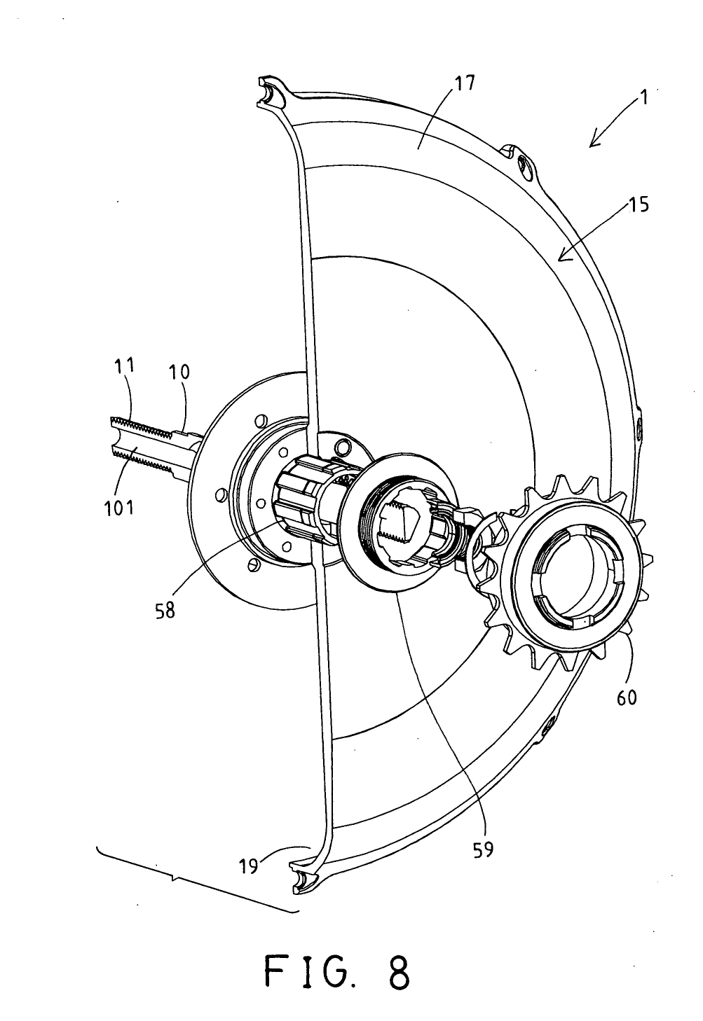

Referring to the drawings, and initially to FIGS. 1-3 and 7-8, a power output device 1 in accordance with the present invention is designed and provided for attaching to either wheel 80 of a wheeled vehicle 8, such as the unicycle, the bicycle, the tricycle, the motorcycle, or other wheeled vehicles, and for attaching to either the front fork mechanism 81 or the rear fork mechanism 82 of the wheeled vehicle 8, and for rotatably coupling the wheel 80 to the fork mechanism 81, 82, and for driving the wheel 80 to rotate relative to the fork mechanism 81, 82 of the wheeled vehicle 8, in which the wheel 80 includes a wheel rim 83, and a number of spokes 84 for coupling the power output device 1 to the wheel rim 83.

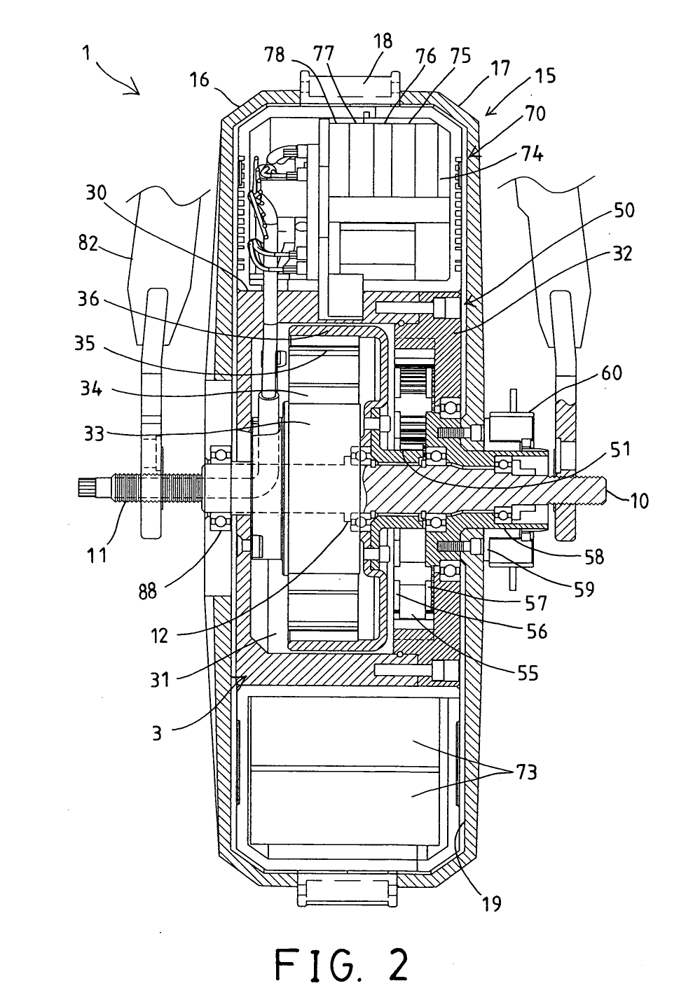

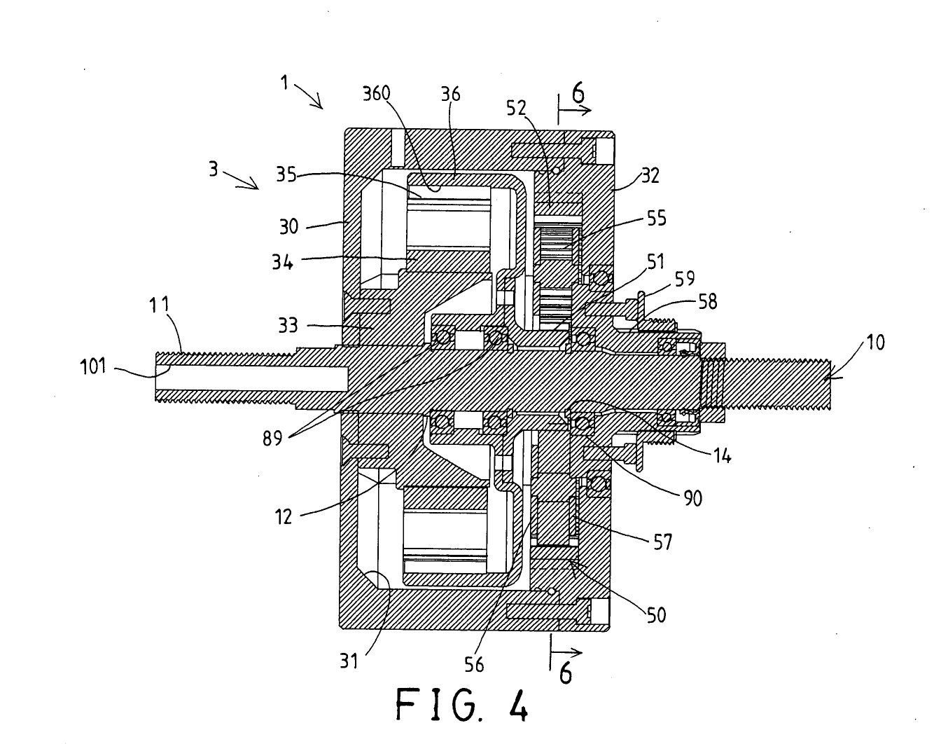

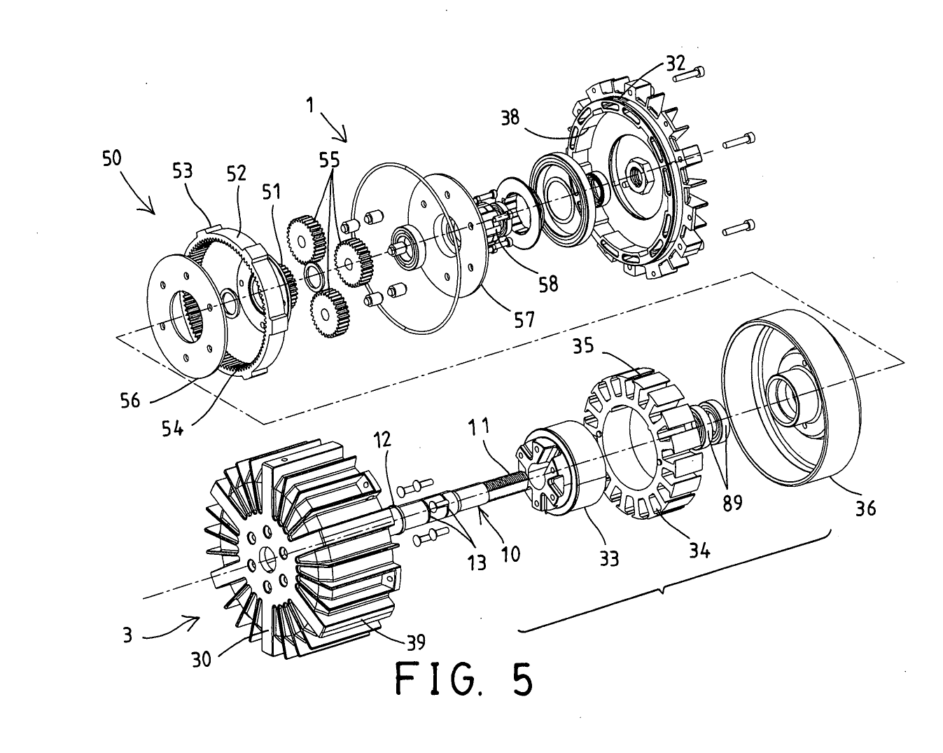

The power output device 1 comprises a spindle 10 including two threaded end portions or segments 11 for threading or engaging with either the front fork mechanism 81 or the rear fork mechanism 82 of the wheeled vehicle 8, and for firmly attaching or mounting or securing the spindle 10 to either fork mechanism 81, 82 of the wheeled vehicle 8, the spindle 10 includes a peripheral flange 12 extended radially and outwardly from an outer peripheral portion thereof (FIGS. 2, 4-5), and includes a number of peripheral slots 13 formed in the outer peripheral portion thereof (FIG. 5) for engaging with clamping or retaining rings 14 (FIG. 4) which may be used for attaching or mounting or securing or anchoring or positioning various parts or elements on the spindle 10.

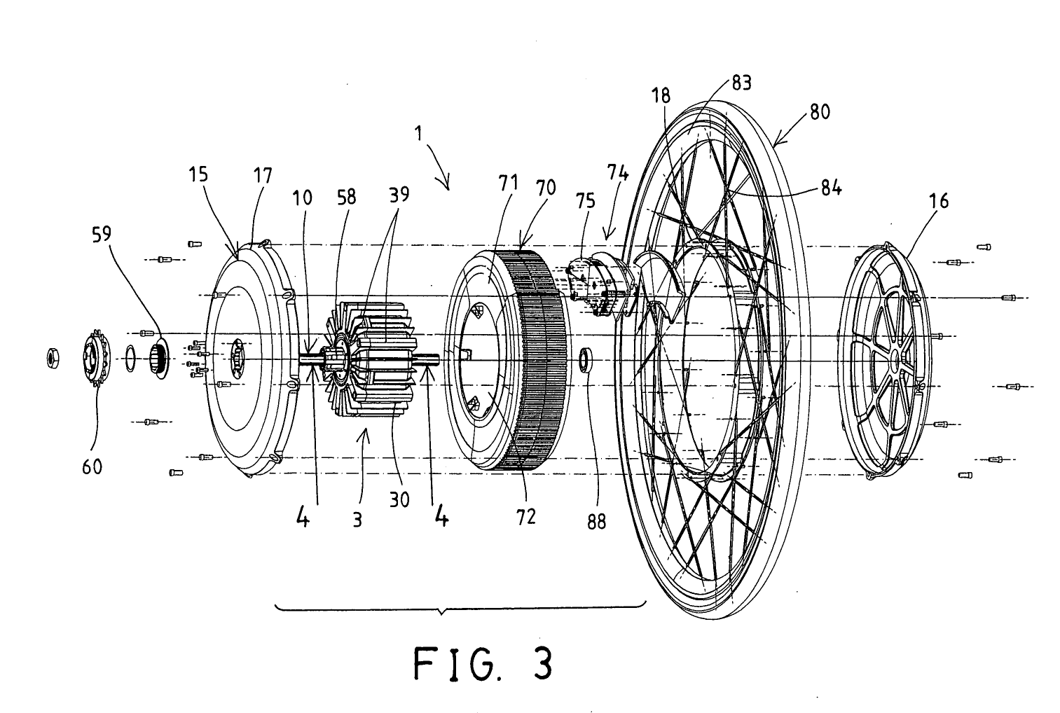

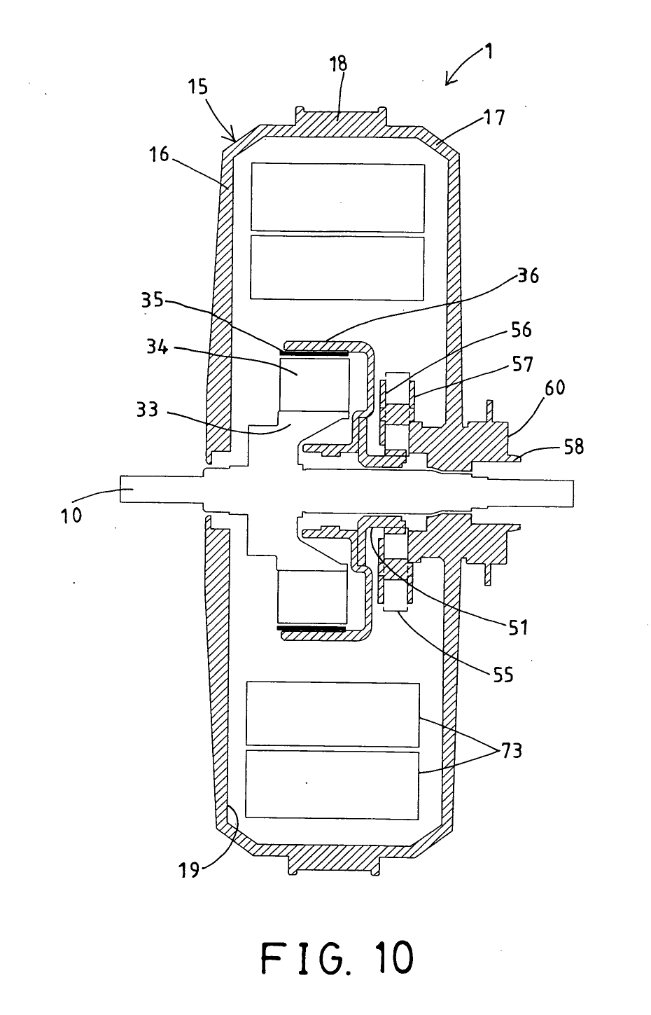

The power output device 1 further comprises an outer housing 15 including two housing members 16, 17 and a central hub member 18 secured together and rotatably attached or mounted or secured onto the spindle 10 with one or more bearings 88 (FIGS. 2, 3), in which the central hub member 18 is attached or mounted or secured to the wheel rim 83 with the spokes 84 for allowing the central hub member 18 of the housing 15 and the wheel rim 83 of the wheel 80 to be rotated relative to the spindle 10 and the fork mechanism 81, 82 of the wheeled vehicle 8. The housing 15 includes a chamber 19 formed therein (FIGS. 2, 10) for receiving a motor assembly 3 and other parts or elements therein, such as the batteries 73 (FIGS. 2, 10) in the chamber 19 of the housing 15.

Referring to FIGS. 2-5, the motor assembly 3 includes a container 30 disposed and engaged in the chamber 19 of the housing 15 and having a compartment 31 formed therein, and includes a cover 32 provided and attached or secured to the side portion of the container 30 for enclosing or covering the compartment 31 of the container 30, a carrier 33 disposed and engaged in the compartment 31 of the container 30 and secured to the container 30, and a stator 34 disposed and engaged in said compartment 31 of said container 30 and/or secured onto the carrier 33 for attaching or supporting one or more magnets 35 on or in the stator 34, in which the carrier 33 or the container 30 is engaged with the peripheral flange 12 of the spindle 10 (FIG. 4) and firmly attached or mounted or secured or anchored to the spindle 10 and thus will not be rotated relative to the spindle 10 and the fork mechanism 81, 82 of the wheeled vehicle 8.

A rotor 36 is rotatably disposed and received or engaged in the compartment 31 of the container 30 and rotatably attached or mounted onto the spindle 10 with one or more bearings 89 (FIGS. 4-5), and includes a space 360 formed therein (FIG. 4) for receiving the carrier 33 and/or the stator 34 and the magnets 35 and for allowing the rotor 36 to be rotated relative to the stator 34 and the magnets 35 in order to generate the electric power. The cover 32 of the container 30 may include one or more depressions 38 formed therein (FIG. 4), and the container 30 and/or the cover 32 may include a number of fins 39 extended radially and outwardly therefrom for heat dissipating purposes or for dissipating the heat that may be generated when the rotor 36 is rotated relative to the stator 34 and the magnets 35 and for preventing various parts or elements from being damaged by the heat.

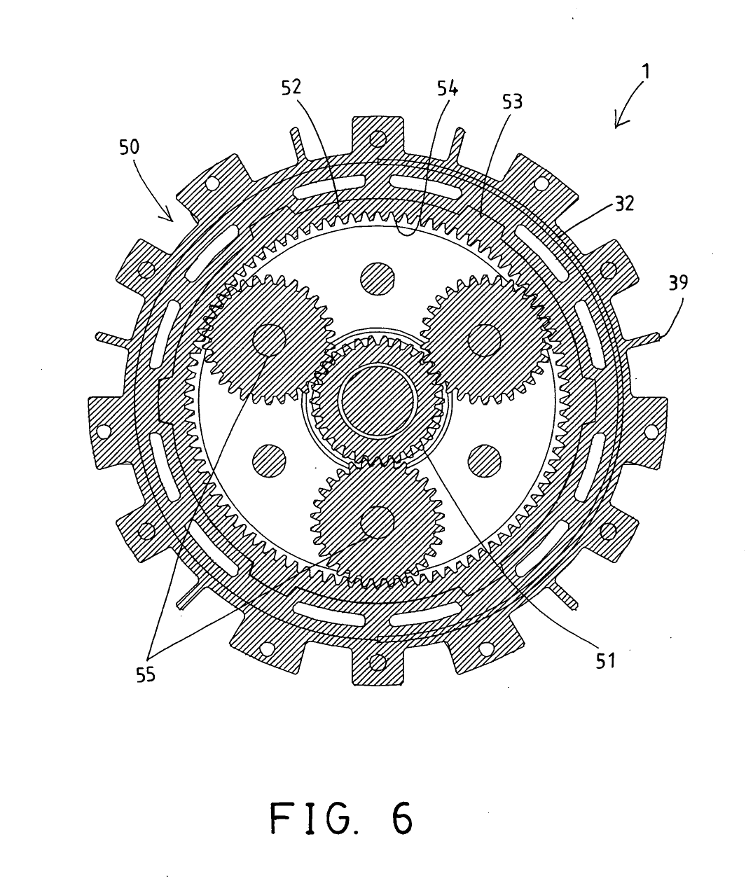

A reduction gearing or transmitting gearing mechanism 50 includes a gear 51 attached or mounted or secured to the rotor 36 and rotated in concert with the rotor 36 relative to the spindle 10, a gear wheel 52 disposed and engaged in the cover 32.of the container 30 and having one or more projections 53 extended radially and outwardly therefrom for engaging with the depressions 38 of the cover 32 and for stably anchoring or positioning or securing the gear wheel 52 to the cover 32 of the container 30 and for preventing the gear wheel 52 from being rotated relative to the cover 32 and the container 30, the gear wheel 52 includes a number of teeth 54 formed or provided therein for engaging with a number of (such as three) pinions 55 which are also meshed or engaged with the gear 51 (FIG. 6).

Two plates 56, 57 are secured to the pinions 55, or the pinions 55 are rotatably disposed and attached or mounted or secured between the plates 56, 57 for allowing the plates 56, 57 and the pinions 55 to be rotated relative to the cover 32 and the container 30 by the rotor 36 and the gear 51. As shown in FIGS. 2-3 and 8-9, an output member or shaft 58 is attached or mounted or secured to the plates 56, 57 and/or the pinions 55 with one or more bearings 90 (FIG. 4) and rotated in concert with the plates 56, 57 and/or the pinions 55, and attached or mounted or secured to the container 30, and a sprocket wheel 60 is optionally attached or mounted or secured to the output shaft 58 directly or indirectly with a coupler 59 for allowing the sprocket wheel 60 and the output shaft 58 to be rotated relative to the cover 32 and the container 30 by the rotor 36 and the gear 51 and the pinions 55 of the gearing mechanism 50.

In operation, as shown in FIG. 10, the carrier 33 and/or the stator 34 and the magnets 35 and the container 30 are solidly or firmly attached or mounted or secured to the spindle 10 and thus will not be rotated relative to the spindle 10 and the fork mechanism 81, 82 of the wheeled vehicle 8, the rotor 36 and the gear 51 and the plates 56, 57 and the pinions 55 and the output shaft 58 and the sprocket wheel 60 are rotatably disposed and attached or mounted to the spindle 10, and the rotor 36 is rotatable relative to the stator 34 and the magnets 35 in order to generate the electric power; or when the power output device 1 is energized, the rotor 36 and the gear 51 may be caused to be rotated relative to the spindle 10 in order to rotate or drive the output shaft 58 and the sprocket wheel 60 through the pinions 55 and the gear 51 and the gear wheel 52, and so as to rotate or drive the housing 15 and the wheel rim 83 of the wheel 80 relative to the spindle 10 and the fork mechanism 81, 82 of the wheeled vehicle 8.

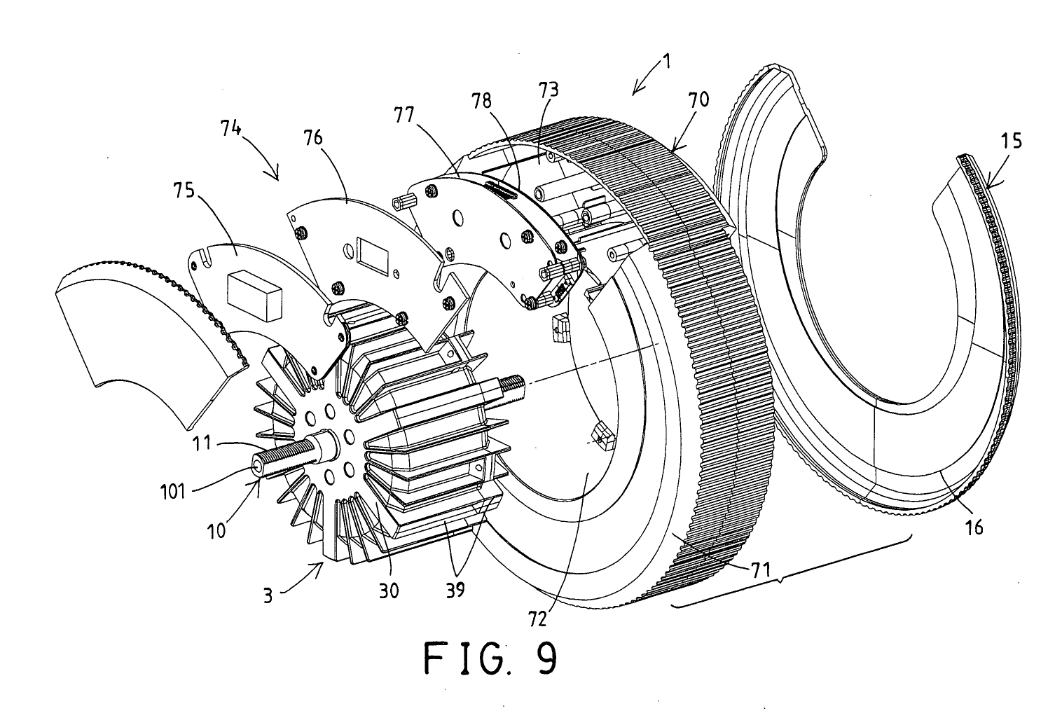

As shown in FIGS. 2-3 and 9-10, an electric power device or control device 70 includes a casing 71 received or engaged in the chamber 19 of the housing 15 and attached or mounted or secured to the container 30, and the casing 71 includes an opening 72 formed therein (FIGS. 3, 9) for receiving the container 30, and firmly secured to the container 30, and the casing 71 includes one or more batteries 73 disposed therein for supplying or applying the electric power to actuate or operate the various electric parts or elements of the power output device 1, and may further include an electric mechanism 74 (FIGS. 2, 9) disposed in the casing 71, for example, the electric mechanism 74 may include a signal receiver 75, a sensor or detector 76, a torque detector 77, a navigating device 78 and/or the other electric parts or elements, such as Zigbee, radio frequency (RF), Bluetooth, subscriber identity module (SIM) card, etc., for detecting the road condition or the environment, such as the light, the temperature, the humidity, the pressure, the magnetic field, the torque, etc. and/or for controlling or for operating or actuating the rotor 36 of the motor assembly 3.

For example, when the torque detector 77 detects that the torque applied to the output shaft 58 and the sprocket wheel 60 is not good enough, the electric mechanism 74 may control the batteries 73 to apply a greater electric power to actuate or operate or rotate or drive the rotor 36 in a greater rotational speed relative to the stator 34 and the magnets 35 in order to generate a greater electric power and so as to apply a greater driving torque to the output shaft 58 and the sprocket wheel 60, and so as to rotate or drive the wheel 80 of the wheeled vehicle 8 in a greater rotational speed. It is to be noted that the housing 15 and the wheel 80 may be rotatably and stably attached or mounted or supported on the spindle 10, and the container 30 of the motor assembly 3 and the control device 70 may also be stably attached or mounted or supported on the spindle 10. The spindle 10 may further include a passage 101 formed therein for receiving or engaging with electric wires or cables (not shown).

Accordingly, the power output device in accordance with the present invention may be provided for attaching to a wheel of a wheeled vehicle and for selectively rotating or driving the wheel of the wheeled vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A power output device for attaching to a wheel and a fork mechanism of a wheeled vehicle, comprising:
a spindle for attaching to the fork mechanism of the wheeled vehicle,
a housing for attaching to the wheel of the wheeled vehicle and including a chamber formed therein, said housing being rotatably attached onto said spindle,
a motor assembly including a container disposed in said chamber of said housing and having a compartment formed therein, a cover attached to a side portion of said container, a stator disposed in said compartment of said container and secured to said container, a rotor engaged in said compartment of said container and rotatably attached to said spindle,
a gear attached to said rotor and rotated in concert with said rotor,
a gear wheel secured to said cover of said container and including a plurality of teeth formed therein,
a plurality of pinions engaged with said gear and said teeth of said gear wheel, and rotatably attached between two plates,
an output shaft attached to one of said plates and attached to said container, and
a control device including at least one battery engaged in said chamber of said housing and attached to said container, and including an electric mechanism for operating said rotor of said motor assembly.

2. The power output device as claimed in claim 1, wherein said cover of said container includes a plurality of depressions formed therein, and said gear wheel includes a plurality of projections extended radially and outwardly therefrom for engaging with said depressions of said cover and for anchoring and securing said gear wheel to said cover of said container.

3. The power output device as claimed in claim 1, wherein said cover and said container includes a plurality of fins extended outwardly therefrom for heat dissipating purposes.

4. The power output device as claimed in claim 1, wherein said electric mechanism includes a signal receiver, a sensor, a torque detector and a navigating device.

5. The power output device as claimed in claim 1, wherein said control device includes a casing engaged in said chamber of said housing and having an opening formed therein for receiving said container, and said at least one battery is engaged in said casing.

6. The power output device as claimed in claim 1, wherein said motor assembly includes a carrier disposed in said compartment of said container and secured to said container, and said stator is secured onto said carrier.

7. The power output device as claimed in claim 6, wherein said spindle includes a peripheral flange engaged with said container for anchoring said container to said spindle.

8. The power output device as claimed in claim 1 further comprising a sprocket wheel attached to said output shaft.

9. The power output device as claimed in claim 8, wherein said sprocket wheel is attached to said output shaft with a coupler.
